(19) United States
(12) Patent Application Publication
(10) Pub. No.: US 2011/0017533 A1
(43) Pub. Date: Jan. 27, 2011

(54) HYBRID TRACTION MOTOR INITIATED REMOTE START-STOP SYSTEM

(75) Inventor: Jay E. Bissontz, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/508,737

(22) Filed: Jul. 24, 2009

(51) Int. Cl. B60K 6/48; B60W 10/04; B60W 20/00

(52) U.S. Cl. 180/65.25; 180/65.265

(57) ABSTRACT

A parallel hybrid electric vehicle is equipped for power take-off operation in both an electrical and a thermal engine mode. A parallel control enables an operator to restart the vehicle's internal combustion engine using a remote command.

### BACKGROUND

1. Technical Field

The technical field relates generally to hybrid motor vehicles and, more particularly, to a hybrid vehicle equipped for a power take-off operation (PTO).

2. Description of the Technical Field

Many medium and heavy duty vehicles in use today (e.g., utility trucks, wreckers, over-the-road tractors and the like) include at least one power take-off operation vocation. Vehicle power-trains employ a power transmission mechanism driven by a prime mover, such as an internal combustion engine, to power a primary vehicle drive shaft. PTO is commonly implemented by employing a secondary drive shaft coupled to the power train to enable the prime mover to independently power a vehicle accessory in addition to one or more of the vehicle wheels. The secondary drive shaft can be coupled to the transmission. PTO may be implemented using a transmission as a hydraulic fluid pump.

Parallel remote controls for the prime mover can be provided at locations on the vehicle outside the cab. For example, on a conventional aerial lift truck an engine start/stop switch may be located in the bucket. On a wrecker an engine start/stop switch may be positioned along the side of the vehicle, which is relatively remote to the vehicle cab. Start/stop switches conventionally operate to allow the engine to be temporarily turned off when not in immediate use to avoid idling losses. An example of such a system is taught in U.S. Pat. No. 6,789,519 to Bell. On vehicles equipped with controller area networks (CAN) this control may be implemented by the vehicle body builder adding some type of data link module. An example of such a module is the remote power module described in U.S. Pat. No. 6,272,402 to Kelwaski (there termed a “Remote Interface Module”). Data link modules can be used, among other applications, to add switches to a vehicle. The functions of the switches may then be defined by the vehicle body builder through suitable programming of a vehicle's body computer. Remote power modules allow a specialized vehicle body builder to conveniently add control arrangements for specialized equipment installed on a vehicle. Remote power/data link modules may be located anywhere on the vehicle that the CAN data link can be tapped into, including the cab. Operator commands entered through a remote power module are termed remote commands and the resulting instructions are termed body inputs.

PTO has been proposed for hybrid electric vehicles equipped with an internal combustion engine and an electric traction motor. U.S. Pat. No. 7,281,595 teaches such a system. In a parallel hybrid electric power train either the internal combustion engine or the electric traction motor can function as the vehicle's prime mover, that is either can be mechanically coupled to deliver motive power to the vehicle wheels, the PTO application, or both, through a power transmission mechanism. PTO modes on such vehicles are distinguished between mechanical (“mPTO”) where the internal combustion engine is the prime mover or electrical (“ePTO”) where the electric traction motor is the prime mover. The PTO vocation may be the same for both mPTO and ePTO. Generally, operation in an ePTO mode is used because an electric motor does not incur idling losses or high parasitic drag which attend use of an internal combustion engine for applications likely to make intermittent power demands or to use relatively little power relative to the engine's potential. The engine may be cut in automatically to switch to mPTO mode if, for example, the traction battery state of charge falls below a minimum level.

### SUMMARY

On a parallel hybrid electric vehicle, use of the vehicle traction motor to crank the vehicle's internal combustion engine in response to a remote operator command or operator generated body input is provided. The hybrid electric vehicle includes a public data bus with a body computer. The body computer receives and processes a plurality of chassis inputs for the control of brakes, running lights, etc. In addition, the body computer receives and processes body/remote inputs from at least a first data link module. The body inputs typically provide for control of vehicle accessories added for power take-off operation.

The data link modules function as extensions of a body computer/electronic system controller (ESC) through a controller area network and control signals entered through such modules are termed “body inputs” to distinguish them from “chassis inputs” based on their source. Control arrangements depending upon body inputs are typically finalized by programming of the body computer. The programming may be specific to a particular vehicle, typically one equipped for PTO by a body builder, and maybe alterable over time.

### BRIEF DESCRIPTION OF THE DRAWINGS

FIG. 1 is a side elevation of a medium duty hybrid utility vehicle equipped for a power take-off operation.

FIG. 2 is a high level block diagram of a control system for the medium duty hybrid utility vehicle of FIG. 1.

FIG. 3 is a system diagram for chassis and body initiated hybrid electric traction motor control for power take-off operation.

FIGS. 4A-B are schematic illustrations of a parallel hybrid power train applied to support a cranking of a vehicle's internal combustion engine.

FIG. 5 is a flow chart for the control system of FIG. 2 relating to handling body stop/start inputs during power take-off operation.

### DETAILED DESCRIPTION

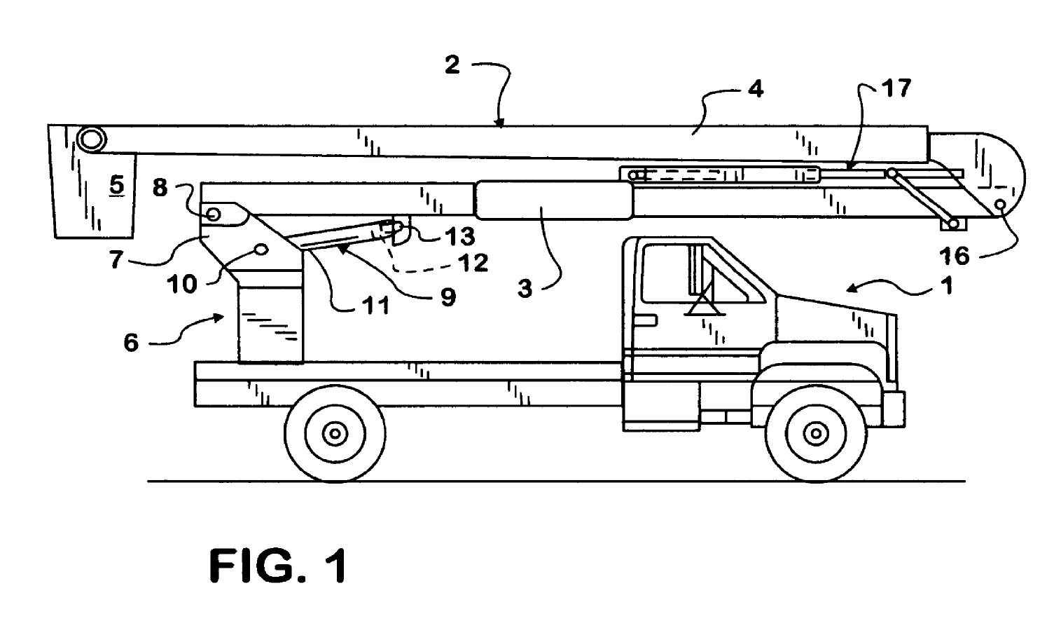

Referring now to the figures and in particular to FIG. 1, a hybrid mobile aerial lift truck 1 is illustrated. Hybrid mobile aerial lift truck 1 serves as an example of a medium duty vehicle which supports a PTO vocation. The mobile aerial lift truck 1 includes a PTO load, here an aerial lift unit 2 mounted to a bed on the back portion of the truck. In preparation for PTO operation, the operator may place the transmission for mobile aerial lift truck 1 in neutral, set the park brake set and deploy outriggers to stabilize the vehicle. Chassis inputs such as an indication that vehicle speed is less than 5 kph may be used to insure the vehicle is in a stationary mode of operation for PTO. Other types of vehicles may use different inputs and indications to determine readiness for PTO. The operator will usually specifically activate PTO by use of a dedicated switch.

The aerial lift unit 2 includes a lower boom 3 and an upper boom 4 pivotally interconnected to each other. The lower boom 3 is in turn mounted to rotate on the truck bed on a support 6 and rotatable support bracket 7. The rotatable support bracket 7 includes a pivoting mount 8 for one end of lower boom 3. A bucket 5 is secured to the free end of upper boom 4 and supports personnel during lifting of the bucket to and support of the bucket within a work area. Bucket 5 is pivotally attached to the free end of boom 4 to maintain a horizontal orientation at all times. A lifting unit 9 is interconnected between bracket 7 and the lower boom 3. A pivot connection 10 connects the lower boom cylinder 11 of unit 9 to the bracket 7. A cylinder rod 12 extends from the cylinder 11 and is pivotally connected to the boom 3 through a pivot 13. Lower boom cylinder unit 9 is connected to a pressurized supply of a suitable hydraulic fluid, which allows the assembly to be lifted and lowered. The primary source of pressurized hydraulic fluid may be an automatic transmission or a separate pump. Either the vehicle's engine or its electric traction motor serves as the prime mover for normal operation, although a back up motor may also be provided. The outer end of the lower boom 3 is interconnected to the lower and pivot end of the upper boom 4. A pivot 16 interconnects the outer end of the lower boom 3 to the pivot end of the upper boom 4. An upper boom compensating cylinder unit or assembly 17 is connected between the lower boom 3 and the upper boom 4 for moving the upper boom about pivot 16 to position the upper boom relative to the lower boom 3. The upper-boom, compensating cylinder unit 17 allows independent movement of the upper boom 4 relative to lower boom 3 and provides compensating motion between the booms to raise the upper boom with the lower boom. Unit 17 is supplied with pressurized hydraulic fluid from the same sources as unit 9.

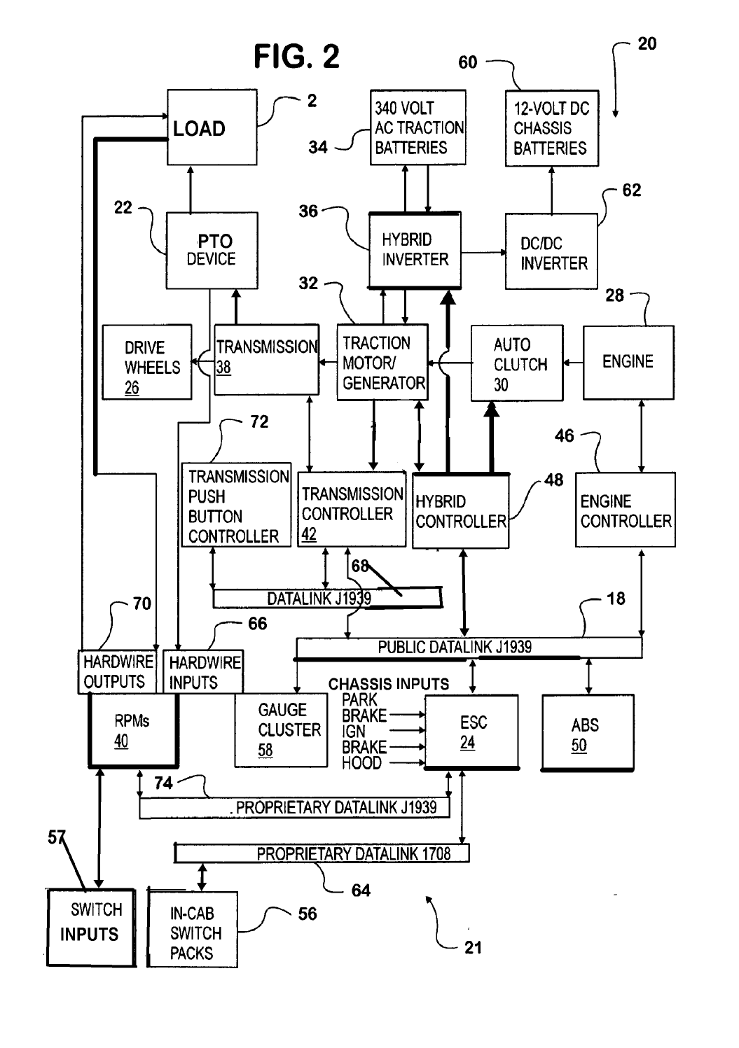

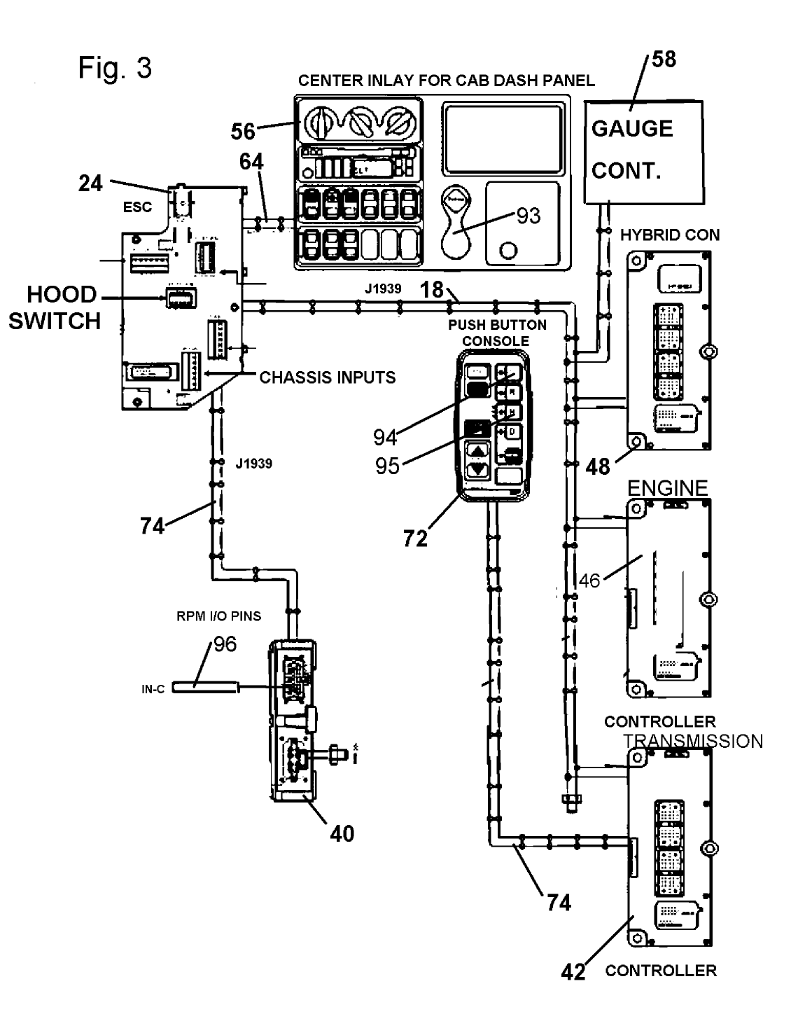

FIGS. 2 and 3, are, respectively a high level schematic of a control system 21 representative of systems used for a parallel hybrid electric drive train 20 and a more detailed illustration of particular components of the control system, including operator controls, are shown. An electronic system controller (ESC) 24, a type of a body computer, is linked by a public datalink 18 (here illustrated as a SAE compliant J1939 CAN bus) to a variety of local controllers which in turn implement direct control over most vehicle and drive train 20 functions. Additional controllers, switch packs and remote power units are connected to the ESC 24 or the transmission controller 42 over proprietary data links. Public and proprietary datalinks differ in that signals on the public datalink 18 conform to an industry wide standard format.

Five controllers in addition to the ESC 24 are illustrated connected to the public datalink 18. The controllers shown are an engine controller 46, a transmission controller 42, a gauge cluster controller 58, a hybrid controller 48 and an antilock brake system controller (ABS) 50. A different set of controllers may be used for different vehicles. Transmission controller and ESC 24 both operate as portals and/or translation devices between the public data link 18 and other vehicle data links. A park brake set switch 93 is included on switch pack/cab dash panel 56. A push button transmission console provides switches for controlling activation of PTO (switch 94) and placing the transmission in neutral (switch 95). Operator toggling of engine operation during PTO is provided on an input 96 to remote power module/data link module 40.

ABS controller 50 controls application of brakes 52 in response to a braking command from ESC 24. ABS controller 50 may be used to measure vehicle speed from wheel speed sensors (not shown) used to implement an anti-skid algorithm. Vehicle speed also may be measured using a transmission tachometer (not shown). In either case, and relevant controller reports vehicle speed in a CAN formatted signal.

“Chassis inputs” include, an ignition switch input, a brake pedal position input, a hood position input and a park brake position sensor, which are connected to supply signals to the ESC 24. Other inputs to ESC 24 may exist. Signals for PTO operational control from within a cab may be implemented using an in-cab switch pack(s) 56. In-cab switch pack 56 is connected to ESC 24 over a proprietary data link 64. ESC 24 responses to the chassis and body inputs can depend upon programming of the ESC 24 to generate throttle commands, brake commands, etc., or may simply involve translating an input in a public CAN formatted signal. CAN signals are typically not “addressed” but are received by any controller connected to the datalink.

Hybrid controller 48 determines, based on available battery charge state, whether the internal combustion engine 28 or the traction motor 32 satisfies requests for power, whether to support PTO or to support locomotion of the vehicle. Hybrid controller 48 with ESC 24 generates the appropriate signals for application to datalink 18 to which the engine controller 46 responds to turn engine 28 on and off and, if on, at what power output to operate the engine. Hybrid controller 42 controls engagement of auto clutch 30. Transmission controller 42 controls the state of transmission 38 in response to transmission push button controller 72, determining the gear the transmission is in or if the transmission is to deliver drive torque to the drive wheels 26 or to a hydraulic pump which is part of PTO system 22 (or simply pressurized hydraulic fluid to PTO system 22 where transmission 38 serves as the hydraulic pump) or if the transmission is to be in neutral.

PTO device 22 control may be implemented through one or more remote power modules (RPMs). Remote power modules are data-linked expansion input/output modules dedicated to the ESC 24, which is programmed to utilize them. Where RPMs 40 function as the PTO controller they can be configured to provide hardwire outputs 70 and hardwire inputs used by the PTO device 22 and to and from the load/aerial lift unit 2. Requests for movement from the aerial lift unit 2 and position reports are applied to the proprietary datalink 74 for transmission to the ESC 24, which translates them into specific requests for the other controllers, e.g. a request for PTO power. ESC 24 is also programmed to control valve states through RPMs 40 in PTO device 22. It is contemplated that the body builders or truck equipment manufacturers (TEMs) who build and install the PTO vocation will equip a vehicle with RPMs 40 to support the PTO and supply a switch pack 57 for connection to the RPM 40. TEMs are colloquially known as “body builders” and signals from an RPM 40 provided for body builder supplied vehicle vocations are termed “body power demand signals” or “body inputs”.

Proprietary data links 68 and 74 operate at substantially higher baud rates than does the public datalink 18, and accordingly, buffering is provided for a message passed from one link to another. Additionally, a message may be reformatted, or a message on one datalink may be changed to another type of message on the second datalink, e.g. a movement request over datalink 74 may translate to a request for transmission engagement from ESC 24 to transmission controller 42. Datalinks 18, 68 and 74 are controller area networks and conform to the SAE J1939 protocol. Datalink 64 conforms to the SAE J1708 protocol. Datalink 64 is a low baud rate data connection, typically on the order of 9.7 Kbaud. Datalink 18, under current practice, supports data transmission at up to 250 Kbaud.

Vehicle 1 is illustrated as a parallel hybrid electric vehicle. In a parallel hybrid electric vehicle the drive train 20 can mechanically or hydraulically couple the output of either an internal combustion engine 28, a traction motor/generator 32, or both, to the drive wheels 26. Drive train 20 comprises an engine 28 connected in line with an auto clutch 30 which allows disconnection of the engine 28 from the rest of the drive train when the engine is not being used for motive power or for recharging battery 34. Auto clutch 30 is directly coupled to the traction motor/generator 32 which in turn is connected to a transmission 38. Transmission 38 is in turn used to apply power from the traction motor/generator 32 to either the PTO system 22 or to drive wheels 26. Transmission 38 is bi-directional and can be used to transmit energy from the drive wheels 26 back to the traction motor/generator 32. Traction motor/generator 32 may be used to provide motive energy (either alone or in cooperation with the engine 28) to transmission 38. When used as a generator the traction motor/generator supplies electricity to inverter 36 which supplies direct current for recharging battery 34.

Drive train 20 recaptures energy from the vehicle's inertial momentum during braking or slowing. This is called regenerative braking. During regenerative braking transmission 30 allows the traction motor 32 to be driven as a generator by being back driven by the vehicle's kinetic force. Auto-clutch 30 is disconnected to isolate the engine 28 from the traction motor/generator 32. The transitions between positive and negative traction motor contribution are detected and managed by a hybrid controller 48. Hybrid controller 48 looks at the ABS controller 50 datalink traffic to determine if regenerative kinetic braking would increase or enhance a wheel slippage condition if regenerative braking were initiated. Transmission controller 42 detects related data traffic on datalink 18 and translates these data as control signals for application to hybrid controller 48 over datalink 68.

Some electrical power may be diverted from hybrid inverter 36 to maintain the charge of a conventional 12-volt DC Chassis battery 60, if present, through a voltage step down DC/DC inverter 62. On the other hand, traction batteries 34 may be the only electrical power storage system for vehicle 1. In vehicles contemporary to the writing of this application numerous 12 volt applications remain in common use and vehicle 1 may be equipped with a parallel 12 volt system to support these systems. This possible parallel system is not shown for the sake of simplicity of illustration. Inclusion of parallel systems allows the use of readily available and inexpensive components designed for motor vehicle use, such as incandescent bulbs for illumination. However, using 12 volt components incurs a vehicle weight penalty and entails extra complexity.

Traction motor/generator 32 may be used to propel vehicle 1 by drawing power from battery 34 through inverter 36, which supplies 3 phase 340 volt rms power. Battery 34 is sometimes referred to as the traction battery to distinguish it from a secondary 12 volt lead acid battery 60 used to supply power to various vehicle systems.

Drive train 20 is one configuration of hybrid drive trains, which supports PTO either from engine 28 or from the traction motor 32. When engine 28 is used for PTO it can be used to concurrently support of PTO operation and to run traction motor/generator 32 in its generator mode to recharge the traction batteries 34. Operation of the PTO vocation by use of the engine 28 is called mechanical PTO (mPTO mode). Operation of the PTO vocation using motor 32 is called electrical PTO (ePTO mode).

High mass utility vehicles have tended to exhibit poorer gains from hybrid locomotion than automobiles. Also, there tends to be a substantial mismatch in the power output capacity of engine 28 and the power demands of PTO system 22. As a result, using the engine 28 to directly run PTO system 22 is usually inefficient due to parasitic losses or idling losses. Greater efficiency is obtained by reserving stored electrical power to run the PTO vocation in ePTO mode, or, if traction battery 34 charge does not permit that, running engine 22 at close to its rated output to recharge battery 34 and then shutting down the engine and using battery 34 to supply electricity to traction motor/generator 32 to operate PTO system 22.

An aerial lift unit 2 is an example of a system which may be used only sporadically by a worker first to raise and later to reposition its basket 5. Operating the aerial lift unit 2 using the traction motor 32 avoids idling of engine 28. Engine 28 runs periodically at an efficient speed to recharge the battery if battery 34 is in a state of relative discharge. In automatic operation, battery 34 state of charge is determined by the hybrid controller 48, which directly controls engagement of the auto-clutch 30 followed by activation of the traction motor/generator 32 in traction motor mode to crank engine 28. Engine controller 46 controls fuel metering to engine 28. The availability of engine 28 may depend on certain programmed (or hardwired) interlocks, such as hood position, which can be based on chassis inputs monitored by the ESC 24.

Where the PTO system 22 is an aerial lift unit 2 it is unlikely that it would be operated when the vehicle was in motion, and the description here assumes that in fact that the vehicle will be stopped for PTO, but for other PTO vocations stopping may be made optional.

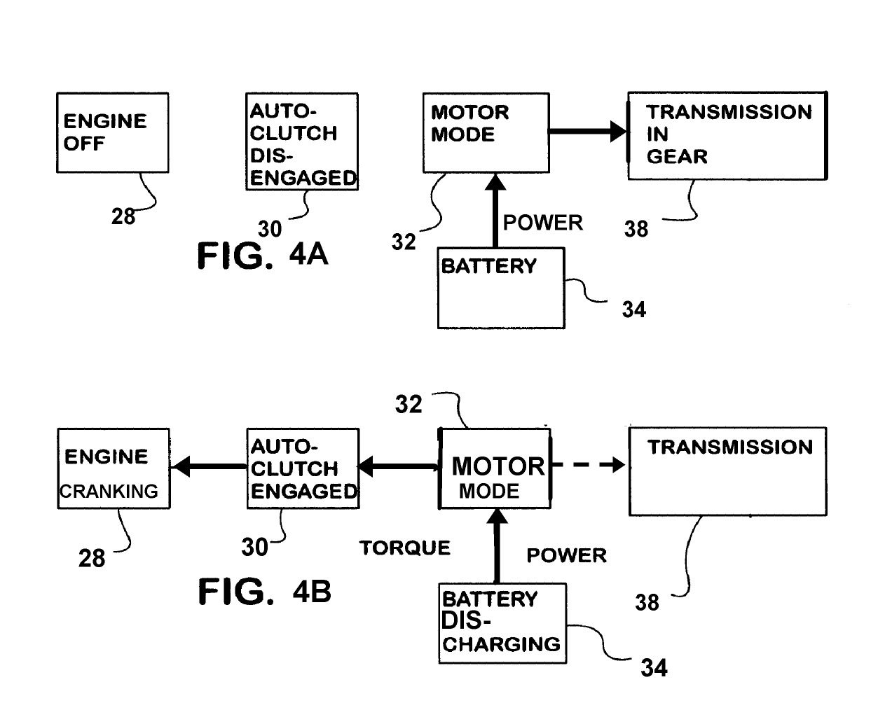

FIGS. 4A-B illustrate graphically what occurs in the vehicle drive train 20 during transition from ePTO to engine cranking. FIG. 4A corresponds to a power take-off operation ready state with the generator 32 in motor mode and the transmission engaged for ePTO mode. The auto-clutch 30 is disengaged. In FIG. 4B the auto-clutch 30 has engaged and generator/motor 32 is used to crank the engine 28. The state of transmission 38 is undefined. It may remain engaged, or be disengaged to limit the load on the battery 34.

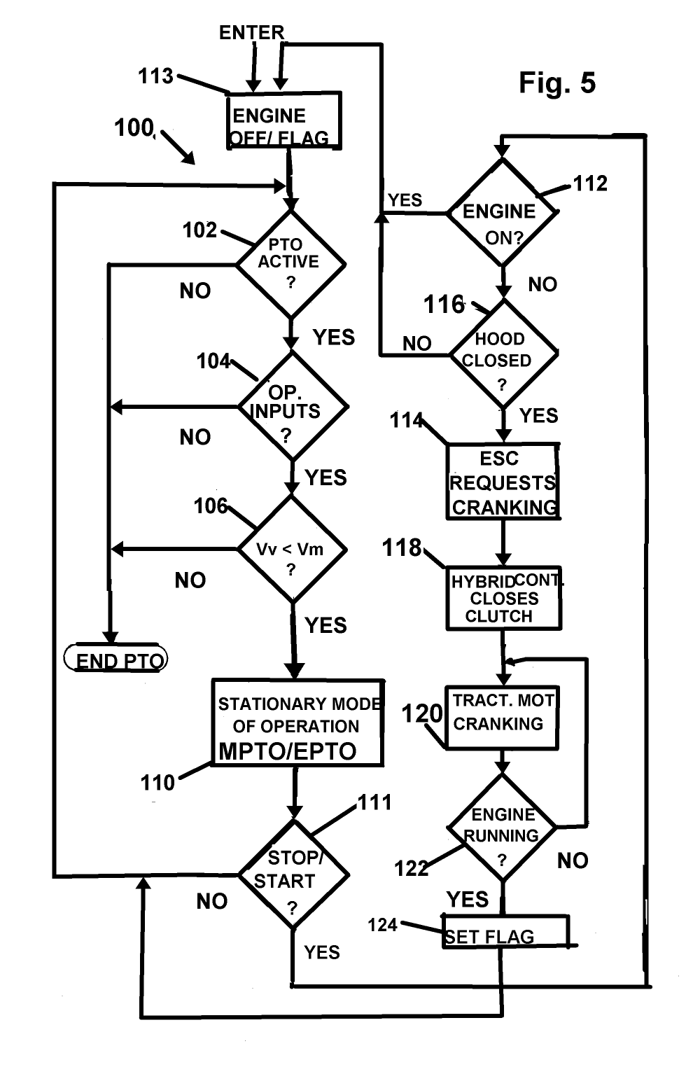

Referring to flow chart 100 of FIG. 5, handling of manually entered stop/start signals for engine 28 on a hybrid vehicle equipped for PTO as handled by the vehicle control system is illustrated in a simplified format. Control flow is illustrated as a closed loop with entry to the loop provided at step 113 and initial entry steps are conflated with steps 102, 104 and 106. The default mode of PTO is ePTO mode and accordingly the engine 28 is turned off and a flag set allowing automatic restarting of the engine 28 upon entry through step 113. Auto-clutch 30 is disengaged. Steps 102, 104 and 106 follow step 113, and provide for confirming that PTO remains active and that the conditions for PTO remain in effect. Confirmation that PTO has been manually activated is provided at step 102. Various operator steps preliminary to PTO are provided (step 104). By way of example, step 104 may involve manual placement of the transmission into neutral and setting the park brake. The vehicle is to be motionless. This is indicated by chassis inputs indicating a vehicle velocity of less than 5 Kph, step 106. PTO is terminated if any of the conditions for PTO fails (the NO branches from steps 102, 104, 106). As long as the conditions remain satisfied, the vehicle will be in a stationary mode of operation (step 110), which may be either ePTO or mPTO.

Stationary mode (step 110) subsumes a variety of steps which are not directly relevant to handling of an operator remote request for stop/start of engine 28. However, automatic stops and starts of engine 28 may occur within step 110 in response to vehicle conditions, such as the battery 34 state of charge or relatively high PTO power demands. Step 110 involves monitoring for change in any of the conditions tested in steps 102, 104 and 106. To reflect such monitoring the routine is illustrated as looping back on itself by step 111 following step 110. Step 111, is illustrated as a decision step determination as to whether an operator has originated a remote stop/start request for engine 28. In not, the NO branch from step 111 loops back to step 102. The YES branch advances processing to step 112. A remote or “body” stop/start input is received by ESC 24 from RPM 40.

A remote stop/start signal is handled by first determining if it is a “stop” signal or a “start” signal which, in turn, depends on whether the engine 28 is running or not. The signal is a stop signal if the engine 28 is running and a start signal if it is not. At step 112 it is determined if the engine 28 is running. If the engine 28 is running the control routine loops back along the YES branch from step 112 to step 113 which reflects ESC 24 directing the engine controller 46 to shut down engine 28 off and the hybrid controller 48 to disengage the auto-clutch 30 (this operation may be made automatic in the absence of a cranking signal and indication that the engine is off). Step 113 provides for resetting a flag to allow automatic starts and stops of the engine of the engine. Where an operator has stopped engine 28 using a remote input during PTO, he or she may be interfering with traction battery 34 recharging. A time out sequence may be provided as part of step 110 which prevents restart of engine 28 under the automatic regime for a few minutes. Following the NO branch from step 112 (i.e. the engine 28 was not running), restart of engine 28 may be blocked by vehicle interlocks. A typical interlock is a provision that the vehicle hood be closed. If it is not the NO branch is followed from step 116 back to step 113 to return the vehicle to an ePTO mode. A warning may be issued to the operator indicating the condition that prevented the engine restart.

If no interlocks are present which would prevent cranking, ESC 24 issues an instruction (step 114) to crank the engine which is operated on by the hybrid controller 48. At step 118 the hybrid controller 48 engages the auto-clutch 30 and then, at step 120, starts the traction motor 32 to crank engine 28. The engine controller 46 concurrently directs injection of fuel into engine 28. Cranking continues (step 122 and the NO branch back to step 120) until the engine 28 starts. Once the engine 28 is running, determined at step 122, the flag blocking automatic stopping of engine 28 is set and execution loops back to step 102 for mPTO mode.

Remote stopping and starting of an engine on a hybrid vehicle equipped for PTO gives the operator more flexibility in control.

1. A vehicle, comprising:
a parallel hybrid drive train including an engine, a traction motor, an automatic clutch for coupling the traction motor and engine to one another allowing the traction motor to crank the engine for starting and a transmission connected to the traction motor;
a control system including a body computer, a hybrid controller and an engine controller communicating over a public datalink;
a secondary datalink connected to the body computer; and
a datalink based module connected to the secondary datalink, the datalink based module being responsive to operator action for generating body inputs for transmission over the secondary datalink to the body computer for requesting stopping or starting of the engine.

2. A vehicle as set forth in claim 1, further comprising:
the body computer being connected to receive a plurality of chassis input signals.

3. A vehicle as set forth in claim 11, further comprising:
the control system operating on the chassis inputs to the body computer for generating interlocks preventing starting the engine when the power takeoff operation is active.

4. A vehicle as set forth in claim 3, further comprising:
the control system being programmed to provide automatic stopping and starting of the engine during power takeoff operation; and
the control system being further programmed for selective suspension of automatic stopping and starting of the engine responsive to operator actions resulting in a body input directing starting of the engine.

5. A drive train, comprising:
an engine, a traction motor, an automatic clutch for coupling the traction motor and engine to one another and a transmission connected to the traction motor;
a power take-off operation run off the transmission from either the traction motor or the engine, the power take-off operation having an active mode and an inactive mode;
a control system including a body computer, a hybrid controller for the traction motor and automatic clutch and an engine controller for the engine, the body computer, hybrid controller and engine controller being connected for communication over a bus; and
a data entry module connected to the body computer for entry of body inputs from an operator directing the body computer to stop or start the engine when the power take-off operation is in the active mode.

6. A drive train as set forth in claim 5, further comprising:
the control system providing for automatic start and stop of the engine in the active mode of the power take-off operation and further being responsive to entry of a body input turning on the engine for suspending automatic stopping of the engine.

7. A vehicle drive train, comprising:
a parallel hybrid drive train including an engine, a traction motor, an automatic clutch for coupling the traction motor and engine to one another and a transmission connected to the traction motor;
a power take-off operation coupled to the transmission;
means for generating chassis input signals;
means for generating remote stop/start signals;
means for controlling the engine responsive to the chassis input signals for activating the power take-off operation and, responsive to a remote stop/start signal occurring with the engine being off, for starting the engine.

8. A vehicle drive train as set forth in claim 7, means for controlling the engine further comprising:
means for controlling the parallel hybrid drive train responsive to chassis and body inputs.

9. A vehicle drive train as set forth in claim 8, further comprising:
the means for controlling the parallel hybrid drive train being responsive to chassis inputs for generating interlocks blocking starting the engine.

10. A vehicle as set forth in claim 9, further comprising:
the means for controlling including programming means for automatically stopping and starting of the engine during power take-off operation; and
the means for controlling further programmed for selective suspension of automatic stopping and starting of the engine responsive to the operator actions.

11. A vehicle as set forth in claim 2, further comprising:
a power take-off operation run off the transmission in an electrical mode based on operation of the traction motor or a mechanical mode based on operation of the engine; and
means responsive to operator action providing body inputs for activating and deactivating the power take-off operation.
